(19) United States
(12) Patent Application Publication
(10) Pub. No.: US 2025/0360533 A1
(43) Pub. Date: Nov. 27, 2025

(54) METHOD AND APPLICATION DEVICE FOR APPLYING A FILLING MATERIAL INTO A CAVITY

(71) Applicant: Dürr Systems AG, Bietigheim-Bissingen (DE)

(72) Inventors: Frank Schnur, Bönnigheim (DE); Sebastian Jochum, Ludwigsburg (DE)

(21) Appl. No.: 18/875,111

(22) PCT Filed: Jun. 5, 2023
(86) PCT No.: PCT/EP2023/065012

§ 371 Date: Dec. 13, 2024

(30) Foreign Application Priority Data
Jun. 13, 2022 (DE) 10 2022 114 834.3

(51) Int. Cl. B05C 11/10; B05C 5/02; B05C 7/00

(52) U.S. Cl. CPC B05C 11/1013; B05C 5/0212; B05C 7/00

(57) ABSTRACT

A method for applying a fluid filling material into a cavity of a component including conveying the filling material by at least one metering device with a predetermined flow rate to an applicator, injecting the filling material by the applicator into the cavity of the component establishing an injection pressure, measuring the injection pressure by means of a pressure sensor, determining a first pressure increase of the injection pressure, and reducing the flow rate of the metering device at a first switchover point at the first pressure increase of the injection pressure.

### CROSS-REFERENCE TO RELATED APPLICATIONS

This application is a national stage of, and claims priority to, Patent Cooperation Treaty Application No. PCT/EP2023/065012, filed on Jun. 5, 2023, which application claims priority to German Application No. DE 10 2022 114 834.3, filed on Jun. 13, 2022, which applications are hereby incorporated herein by reference in their entireties.

### TECHNICAL FIELD

The disclosure relates to a method for applying a fluid filling material into a cavity of a component, in particular in a battery module of an electric battery, in particular for gap filling in a battery module. The disclosure also relates to a corresponding application device.

### BACKGROUND

In the production of battery modules for electromobility, thermally conductive filling materials are used to fill cavities in the battery modules and to thermally couple the battery cells in the battery modules with the housing of the respective battery module. For this purpose, so-called “gap fillers” or “thermal interface materials” (TIM) are used as filling materials, which are usually highly viscous, heavily filled with solids and highly abrasive and also have a high density and thus a correspondingly high weight.

DE 10 2019 109 208 B3 discloses an application device and a corresponding application method that make it possible to inject such a filling material into a cavity of a battery module.

A disadvantage of this known prior art is the fact that the filling material can swell out of the battery module at the end of an injection process, which is undesirable.

With regard to the technical background of the disclosure, reference should also be made to JP 2003-208 888 A, DE 10 2021 118 644 A1 and WO 2014/127 277 A1.

### BRIEF DESCRIPTION OF THE DRAWINGS

FIG. 1 shows a schematic representation of an application device according to the disclosed technology for injecting a thermally conductive filling material into a cavity of a battery module.

FIG. 2 shows a flow chart to explain the operating procedure of the application device from FIG. 1.

FIG. 3 shows a diagram with the curves of the injection pressure and the flow rate during an injection process.

FIG. 4A shows a perspective view of an application device according to the disclosure with a traverse with an applicator and two pressure sensors.

FIG. 4B shows a cross-sectional view of the application device according to FIG. 4A.

FIG. 4C shows a cross-sectional view through the applicator of the application device according to FIGS. 4A and 4B.

FIG. 4D shows a cross-sectional view of the application device as shown in FIGS. 4A-4C.

### DETAILED DESCRIPTION

The disclosed technology is based on the task of preventing the filling material from swelling out at the end of the injection process during injection-filling of cavities in battery modules.

This task is solved by a method or a corresponding application device according to the disclosed technology.

The method according to the disclosure is generally used for applying a fluid filling material into a cavity of a component. In an embodiment of the disclosure, the component is a battery module of an electric battery. However, the disclosure is not limited to a battery module with regard to the component, but is also suitable for filling cavities in other components.

With regard to the filling material to be injected, it should be mentioned that this may be a thermally conductive filling material, whereby such thermally conductive filling materials are also known as “gap fillers” or “thermal interface materials” (TIM) and therefore do not need to be described further with regard to their composition. However, the disclosure is not limited to such thermally conductive filling materials with regard to the filling material. For example, the filling material can also be a thick material, such as an insulating material, a sealant or an adhesive, to name just a few examples.

The method according to the disclosure initially provides, in accordance with the application method described at the beginning, that the filling material is conveyed to an applicator by at least one metering device with a predetermined flow rate.

The term “metering device” used in the context of the disclosure means that the flow rate at the outlet of the metering device is independent of the pressure ratios between the inlet and outlet of the metering device. This is to be distinguished from normal pumps, which also deliver a flow rate, but which depends on the pressure ratios at the outlet of the pump. However, the disclosure is not limited to the metering devices described above in the narrower sense according to the usual meaning in technical terminology with regard to the design and operation of the metering device. The term metering device used in the context of the disclosure can therefore also include conventional pumps.

Furthermore, in accordance with the method described at the beginning, the method according to the disclosure provides that the applicator injects the filling material into the cavity of the component, whereby a certain injection pressure is established.

Furthermore, in accordance with the prior art, the method according to the disclosure also provides for the injection pressure of the filling material to be measured by a pressure sensor.

However, the pressure measurement in the context of the disclosure has a different technical purpose than in the prior art described at the beginning. Thus, the disclosure is based on the technical-physical realization that the disturbing swelling of the filling material out of the battery module at the end of an injection process is due to the fact that the walls of the cavity are elastic and are slightly deformed during an injection process due to the injection pressure. At the end of an injection process, switching off the injection pressure results in the elastic walls of the cavity being relieved and moving back to their initial position, which leads to the disruptive pushing out of the filling material from the cavity.

The method according to the disclosure therefore provides for the pressure increase of the injection pressure to be determined during an injection process, the pressure increase being based on the fact that an injection front of the filling material in the cavity meets the walls of the cavity and experiences a corresponding counterpressure from the walls of the cavity. The pressure increase is measured by the aforementioned pressure sensor. At a certain pressure increase of the injection pressure, a switchover point is then provided at which the flow rate of the metering device is reduced. This means that the cavity is initially filled with the filling material at the start of an injection process with a high flow rate. The injection pressure then rises sharply at first and then drops slightly after reaching a maximum value. However, the injection pressure then rises again when the injection front of the filling material in the cavity meets the walls of the cavity. At this point, the flow rate is then switched to a lower flow rate.

With regard to the term “pressure increase” used in the context of the disclosure, it should be noted that the respective pressure increase does not necessarily lead to a global maximum. Rather, it is also possible that the respective pressure increase only leads to a local maximum.

The flow rate can be reduced at the first switchover point, for example by an absolute reduction value or by a percentage reduction value, whereby the reduction value can optionally also take into account the geometric properties of the cavity (e.g. shape, volume). In addition, the reduction value can optionally depend on the viscosity of the filling material.

When determining the time of the first switchover point for reducing the flow rate, it is not the injection pressure itself that is evaluated, but the time gradient of the injection pressure. The first switchover point for reducing the flow rate is then set to a point in time at which the time gradient of the measured injection pressure exceeds a specific first limit value, whereby the first limit value is positive, but can also be zero or negative.

After the above-described reduction of the flow rate at the first switchover point, the flow rate and the injection pressure initially remain largely constant. The injection pressure only increases again immediately before the cavity is completely filled. At this point, a second switchover point is then provided at which the flow rate of the metering device is further reduced.

To determine the timing of the second switchover point, the time gradient of the measured injection pressure is evaluated again, i.e. the second switchover point is determined as a function of the time gradient of the measured injection pressure.

The second switchover point may be set to a point in time when the time gradient of the measured injection pressure becomes positive or exceeds a predetermined second limit value. The second limit value can optionally be positive, zero or negative. Furthermore, within the scope of the disclosure, it is possible for the two limit values for the temporal gradient of the injection pressure to be the same. Alternatively, however, it is also possible for the two limit values for the temporal gradient of the injection pressure to be different at the first switchover point and at the second switchover point.

It has already been mentioned above that the flow rate is further reduced at the second switchover point in order to prevent overfilling of the cavity with the filling material. For example, the flow rate can be reduced to zero at the second switchover point. In an embodiment, however, the flow rate is first reduced to a negative flow rate at the second flow rate in order to quickly reduce the injection pressure to zero. Only then is the flow rate reduced to zero.

In general, it should also be mentioned that the filling material can be mixed from several components by means of a mixer, whereby the pressure sensor can measure the injection pressure at the outlet of the mixer. However, it is also possible within the scope of the disclosure for several pressure sensors to be provided which measure the injection pressure of the various components upstream of the mixer.

The method according to the disclosure has been described above. However, the disclosure also claims protection for a corresponding application device comprising an applicator, a metering device, a pressure sensor and a control unit which interrogates the first pressure sensor and controls the metering device accordingly.

The control unit can be characterized by the fact that it carries out the above-described method according to the disclosed technology during operation. For this purpose, the control unit can have a control computer on which a control program runs that executes the method according to the disclosure described above when it is executed.

However, it is also possible within the scope of the disclosure that the application device according to the disclosure is characterized by the fact that the pressure sensor is mechanically connected to the applicator and is moved together with the applicator, for example by an application robot.

In an embodiment of the disclosure, the application device includes two pressure sensors in order to measure the injection pressure of the filling material, with the second pressure sensor also being mechanically connected to the applicator and being moved together with the applicator. The filling material is usually injected into an injection opening on the component and can exit the cavity again from two riser openings to prevent overfilling. The two pressure sensors are then positioned in such a way that they measure the injection pressure of the filling material at the riser openings of the component.

Alternatively, however, it is also possible for the second pressure sensor to be arranged separately from the applicator, for example on a plug of an opening in the cavity or on a wall of the cavity.

In an embodiment of the disclosure, the application device includes a traverse, whereby the two pressure sensors are attached to the opposite ends of the traverse in order to measure the injection pressure at the two riser openings on the component. The applicator may also be attached to the traverse, in the middle between the two pressure sensors.

It should be mentioned here that the pressure sensors are each mounted on a bearing point on the traverse, whereby the bearing point allows the pressure sensors to move out of their neutral position relative to the traverse. This prevents damage to the pressure sensors or the riser openings on the component when the application device is placed on the component. The evasive movement of the pressure sensors is aligned at right angles to the application direction. The bearing point can optionally have a spring or a compressed air supply to return the respective pressure sensor to its neutral position.

Furthermore, within the scope of the disclosure, it is possible for the applicator to be detachably connected to the traverse by a bayonet lock. This bayonet lock can optionally also contain a cable bushing for sensor cables of the pressure sensors.

The individual pressure sensors can have a conical tip in order to achieve self-centering of the respective pressure sensor in the associated riser opening on the component. The applicator can also have a corresponding conical tip in order to effect self-centering of the applicator in the associated injection opening on the component.

The conical tip can carry a sealing ring in order to seal the conical tip in the respective opening (injection opening or riser opening).

Furthermore, the application device according to the disclosure may include an application robot for positioning the traverse with the applicator attached to the traverse and the pressure sensors attached to the traverse.

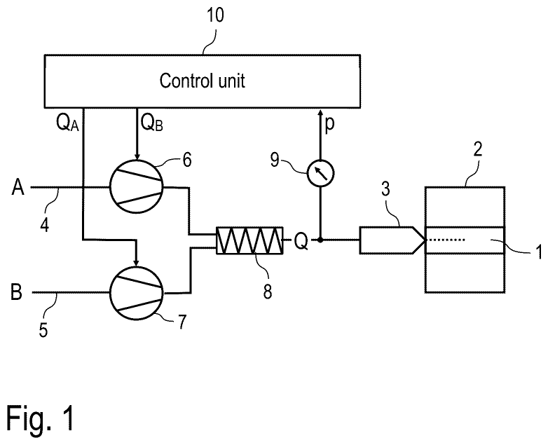

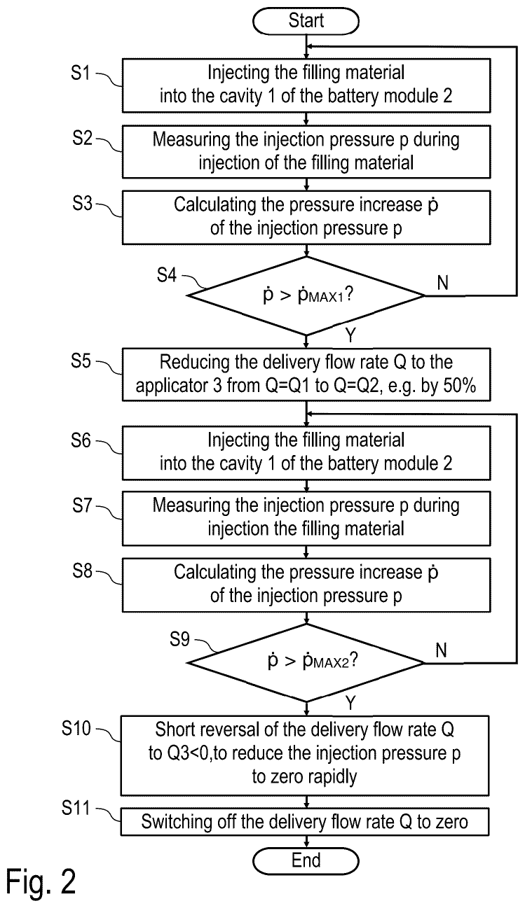

In the following, the embodiment of an application device according to the disclosure shown in FIG. 1 is described, whereby the mode of operation of this application device is shown in FIG. 2 in the form of a flow chart.

The application device according to the disclosure is used to inject a thermally conductive filling material into a cavity 1 in a battery module 2, whereby the battery module 2 with the cavity 1 is only shown schematically here.

To inject the filling material into the cavity 1, the application device includes an applicator 3, which can be placed on an injection opening on the cavity 1 to inject the filling material.

The filling material includes two components A and B, which are supplied via two supply lines 4, 5, whereby a metering device 6, 7 is arranged in each of the two supply lines 4, 5. The two metering devices 6, 7 meter the two components A, B of the filling material out at a specific flow rate Q_{A} or Q_{B} to a mixer 8, which mixes the two components A, B to form the filling material. In this embodiment, the mixer 8 is a static mixer, such as a grid mixer or spiral mixer.

The filling material mixed from the two components A, B then flows from the mixer 8 to the applicator 3 at a flow rate Q and is injected into the cavity 1 of the battery module 2.

Between the mixer 8 and the applicator 3, a pressure sensor 9 measures the injection pressure p with which the filling material is injected into the cavity 1 and forwards the measured value of the injection pressure p to a control unit 10. The control unit 10 then controls the two metering devices 6, 7 in such a way that they deliver the desired flow rate Q_{A} or Q_{B} to the mixer 8.

With regard to the specified pressure values, it should generally be noted that these are related to an ambient pressure p₀, which forms a reference pressure. With an ambient pressure p₀=1 bar (atmospheric pressure), a (relative) pressure value of p=2 bar therefore means that the absolute pressure is 3 bar.

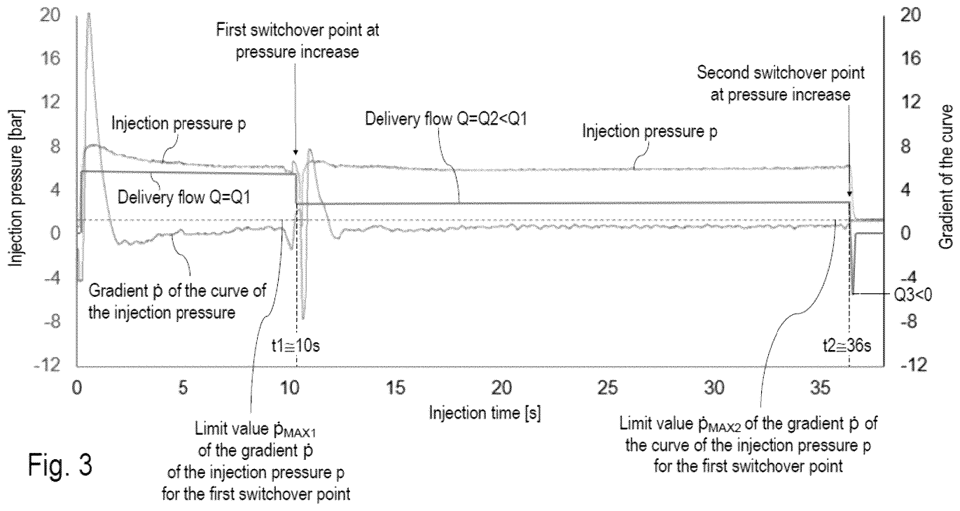

With reference to the flow chart in FIG. 2 and the diagram in FIG. 3, the operating mode of the application device in FIG. 1 is now described below. It should be mentioned here that the steps described in succession below take place in part simultaneously during operation.

In a first step S1, the filling material is injected into the cavity 1 of the battery module 2 by the applicator 3.

In a step S2, the injection pressure p is measured by the pressure sensor 9.

In a step S3, the pressure increase \dot{p} of the injection pressure p is measured, i.e. the change dp/dt of the injection pressure p over time.

If the pressure increase \dot{p} does not exceed a predefined maximum value \dot{p}_{MAX1}, steps S1-S4 are repeated in a loop.

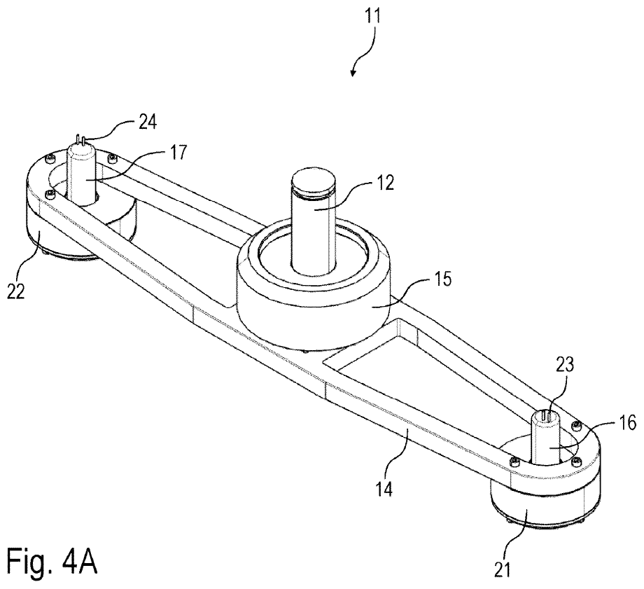

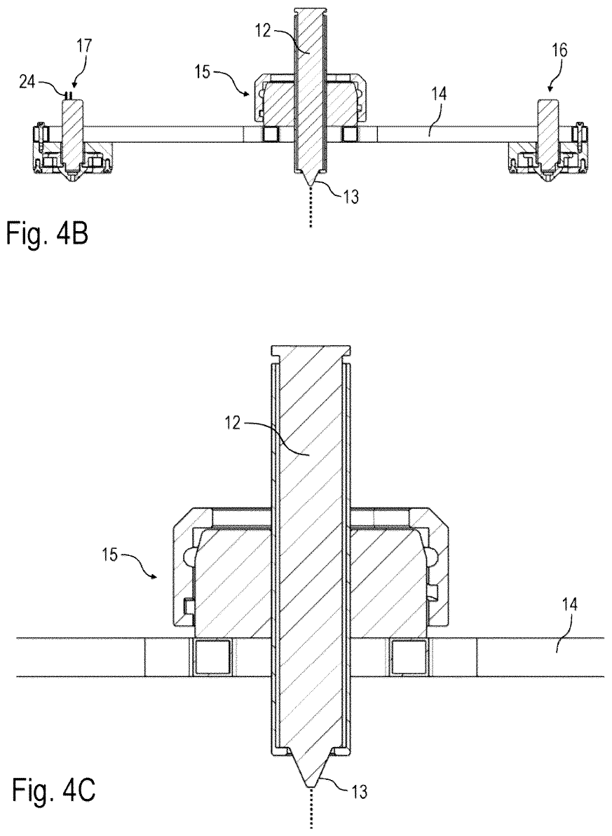

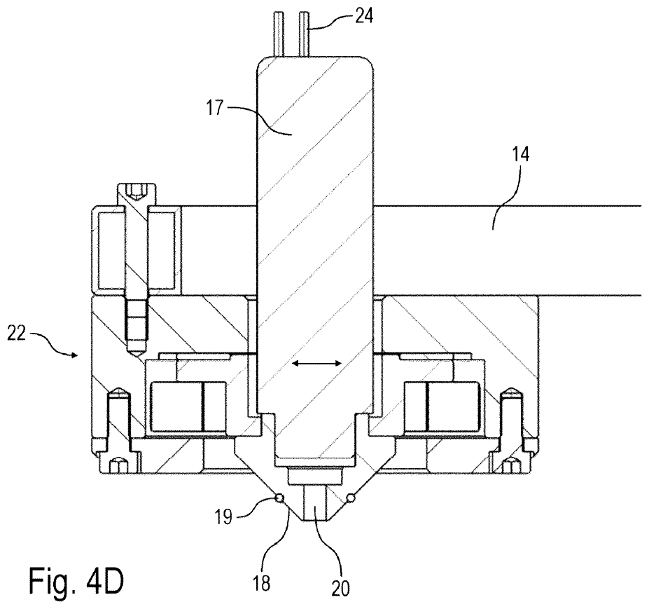

If, however, the determined pressure increase \dot{p} exceeds the maximum value \dot{p}_{MAX1}, the flow rate Q to the applicator 3 is reduced in step S5 from a value Q=Q1 to Q=Q2, for example by 50 percent. In the diagram in FIG. 4, this occurs at the time t=t1 at a first switchover point. The pressure increase \dot{p} at the first switchover point can be attributed to the fact that the injection front of the filling material in the previously unfilled cavity 1 of the battery module 2 meets the walls of the cavity 1, which leads to a corresponding increase in pressure.

In the next step S6, the injection of the filling material into the cavity 1 of the battery module 2 continues.

In the next step S7, the injection pressure p is measured again during the injection of the filling material into the cavity 1 of the battery module 2.

In the next step S8, the pressure increase \dot{p} of the injection pressure p is measured again.

Step S9 then checks whether the pressure increase \dot{p} exceeds a predetermined second maximum value \dot{p}_{MAX2}. In the diagram shown in FIG. 3, the two maximum values \dot{p}_{MAX1} and \dot{p}_{MAX2} are the same. However, within the scope of the disclosure, it is also possible that the two maximum values \dot{p}_{MAX1} and \dot{p}_{MAX2} are equal or different.

If the pressure increase \dot{p} does not exceed the predetermined second maximum value \dot{p}_{MAX2}, steps S6-S9 are repeated in a loop.

Otherwise, however, the flow rate Q is briefly reversed to Q=Q3<0 in a step S10 in order to quickly reduce the injection pressure p to zero. In the diagram shown in FIG. 3, this occurs at the second switchover point at time t=t2.

The increase in pressure at the second switchover point at time t=t2 is due to the fact that the cavity 1 in the battery module 2 is almost completely filled.

Finally, the flow rate Q is then completely switched off in a step S11.

An advantage of the operating method according to the disclosure described above is the fact that no filling material escapes from the cavity 1 of the battery module 2 after the injection process. The disruptive swelling of the filling material out of the cavity 1 of the battery module 2 is therefore completely pre-vented.

In the following, the embodiment of an application device 11 according to the disclosure, which can be used for injecting a thermally conductive filling material into a cavity of a battery module, shown in FIGS. 4A-4D, is described.

The application device 11 includes an applicator 12, which is used to inject the filling material and has a conical tip 13, whereby the conical tip 13 enables the applicator 12 to self-center in the injection opening when the applicator 12 is placed on an injection opening on a battery module.

In addition, the applicator 11 includes a traverse 14, wherein the traverse 14 is connected to the applicator 12 by a bayonet lock 15. The bayonet lock 15 enables an easily detachable connection between the applicator 12 on the one hand and the traverse 14 on the other.

A pressure sensor 16, 17 for measuring the injection pressure at two riser openings of the battery module is located at each of the two opposite ends of the traverse 14. The filling material is thus injected into the battery module by the applicator 12 through the injection opening and can then finally escape again from the riser openings of the battery module as the filling level increases, but this should be prevented. During an injection process, the pressure sensors 16, 17 are then placed on the two riser openings in order to measure the injection pressure in the battery module at the riser openings.

The two pressure sensors 16, 17 each have a conical tip 18 to enable self-centering of the respective pressure sensor 16, 17 in the associated riser opening.

The conical tips 18 each have a sealing ring 19 to seal the conical tip 18 in the associated riser opening.

FIG. 4D also shows that the pressure sensors 16, 17 each have a measuring opening 20 to measure the injection pressure at the respective riser opening.

It should also be mentioned that the two pressure sensors 16, 17 are each mounted in a bearing point 21, 22 at the opposite ends of the traverse 14. It should be mentioned here that the two bearing points 21, 22 each allow the pressure sensor 16, 17 to be flexibly mounted in the respective bearing point 21, 22, as shown by the double arrow in FIG. 4D. This avoids mechanical stresses between the battery module on the one hand and the pressure sensors 16, 17 on the other.

Furthermore, it can be seen that the pressure sensors have sensor cables 23, 24 in order to forward the respective measured pressure values.

1-19. (canceled)

20. A method for applying a fluid filling material into a cavity of a component, the method comprising:
conveying the filling material by at least one metering device with a predetermined flow rate to an applicator;
injecting the filling material into the cavity of the component by the applicator, whereby an injection pressure is established;
measuring the injection pressure by a pressure sensor;
determining a first pressure increase of the injection pressure, the first pressure increase being based on the fact that an injection front of the filling material in the cavity meets walls and experiences a corresponding counterpressure by the walls of the cavity; and
reducing the flow rate of the metering device at a first switchover point at the first pressure increase of the injection pressure.

21. The method according to claim 20, wherein the first pressure increase of the injection pressure is detected and forms the first switchover point when the injection pressure drops again after a sharp increase at the beginning of an injection process and reaching a maximum value and then rises again, when the injection front of the filling material in the cavity meets the walls of the cavity, the reduction of the flow rate then taking place at this point in time of the renewed increase in the pressure rise of the injection pressure.

22. The method according to claim 21, wherein the reduction of the flow rate at the first switchover point takes place by an absolute or by a percentage reduction value.

23. The method according to claim 22, wherein the reduction value is dependent on geometric properties of the cavity.

24. The method according to claim 22, wherein the reduction value is dependent on the viscosity of the filling material.

25. The method according to claim 20, further comprising:
determining the temporal gradient of the measured injection pressure;
determining the timing of the first switchover point by evaluating the temporal gradient of the measured injection pressure.

26. The method according to claim 25, wherein the first switchover point is fixed at a time at which the temporal gradient of the measured injection pressure becomes positive or exceeds a predetermined first limit value.

27. The method according to claim 26, wherein the predetermined first limit value is positive.

28. The method according to claim 20, further comprising:
determining a second pressure increase of the injection pressure, the second pressure increase of the injection pressure being based on the fact that the cavity is almost completely filled with the filling material; and
reducing the flow rate of the metering device at a second switchover point at the second pressure increase of the injection pressure.

29. The method according to claim 28, further comprising:
determining the temporal gradient of the measured injection pressure; and
determining the timing of the second switchover point with the second pressure increase of the injection pressure by evaluating the time gradient of the measured injection pressure.

30. The method according to claim 29, wherein the second switchover point is set to a time when the temporal gradient of the measured injection pressure becomes positive or exceeds a predetermined second limit value.

31. The method according to claim 30, wherein the predetermined second limit value is positive.

32. The method according to claim 31, wherein the predetermined second limit value is equal to the first limit value.

33. The method according to claim 28, wherein the flow rate is reduced to zero at the second switchover point.

34. The method according to claim 28, wherein the flow rate of the metering device is initially reduced to a negative flow rate at the second switchover point in order to reduce the injection pressure to zero, and the flow rate of the metering device is then reduced to zero after the second switchover point.

35. The method according to claim 20, wherein the filling material is mixed from multiple components by means of a mixer, and the pressure sensor measures the injection pressure at the outlet of the mixer.

36. An application device for applying a fluid filling material into a cavity of a component, comprising:
an applicator for injecting the filling material into the cavity, whereby an injection pressure is established;
at least one metering device for conveying the filling material to the applicator at a specific flow rate;
a first pressure sensor for measuring the injection pressure of the filling material; and
a control unit which interrogates the first pressure sensor and controls the metering device, wherein the control unit is adapted to carry out the method according to claim 20.

37. An application device for applying a fluid filling material into a cavity of a component, comprising:
an applicator for injecting the filling material into the cavity, whereby an injection pressure is established;
at least one metering device for conveying the filling material to the applicator at a specific flow rate;
a first pressure sensor for measuring the injection pressure of the filling material; and
a control unit which interrogates the first pressure sensor and controls the metering device, wherein the first pressure sensor is mechanically connected to the applicator and is movable together with the applicator.

38. The application device according to claim 37, further comprising a second pressure sensor for measuring the injection pressure of the filling material.

39. The application device according to claim 38, wherein the second pressure sensor is also mechanically connected to the applicator and is movable together with the applicator.

40. The application device according to claim 39, wherein the second pressure sensor is arranged separately from the applicator.

41. The application device according to claim 40, wherein the second pressure sensor is arranged on a plug of an opening of the cavity.

42. The application device according to claim 40, wherein the second pressure sensor is arranged on a wall of the cavity.

43. The application device according to claim 39, wherein the two pressure sensors are mounted at the opposite ends of a traverse in order to measure the injection pressure at two riser openings on the component, the riser openings allowing excess filling material to escape from the cavity of the component, and the applicator is mounted between the two pressure sensors on the traverse, in order to inject the filling material into an injection opening on the component.

44. The application device according to claim 43, wherein the pressure sensors are each mounted on the traverse in a bearing point, the bearing point enabling an evasive movement of the pressure sensors from their neutral position relative to the traverse.

45. The application device according to claim 44, wherein the evasive movement of the pressure sensors is oriented at right angles to the application direction of the applicator.

46. The application device according to claim 44, wherein the bearing point has a spring or a compressed air supply in order to return the respective pressure sensor to its neutral position.

47. The application device according to claim 43, wherein the applicator is connected to the traverse by a bayonet lock, the bayonet lock optionally also contains a cable bushing for sensor cables of the pressure sensors.

48. The application device according to claim 38, wherein each of the pressure sensors has a respective conical tip in order to effect self-centering of the pressure sensor in the associated riser opening on the component, the applicator has a conical tip to effect self-centering of the applicator in the associated injection opening on the component, and the conical tip of the pressure sensors carries a sealing ring to seal the associated riser opening on the component when the conical tip of the pressure sensor is inserted into the associated riser opening.

49. The application device according to claim 43, further comprising an application robot for positioning the traverse with the applicator attached to the traverse and the pressure sensors attached to the traverse.
